(19) United States
(12) Patent Application Publication
(10) Pub. No.: US 2018/0264515 A1
(43) Pub. Date: Sep. 20, 2018

(54) METHODS AND APPARATUS FOR PRODUCING COATED ARTICLES

(71) Applicant: THE TRUSTEES OF THE SELECTACOAT PENSION SCHEME, Bristol (GB)

(72) Inventor: James Brian HEYS, Hertfordshire (GB)

(73) Assignee: THE TRUSTEES OF THE SELECTACOAT PENSION SCHEME, Bristol (GB)

(21) Appl. No.: 15/542,949

(22) PCT Filed: Feb. 9, 2016
(86) PCT No.: PCT/EP2016/052751

§ 371 Date: Jul. 12, 2017

(30) Foreign Application Priority Data
Feb. 10, 2015 (EP) 15154575.3

(51) Int. Cl. B05D 1/26; B05D 3/06; B05D 7/02; B05C 5/02; B05C 5/00

(52) U.S. Cl. CPC B05D 1/26; B05D 3/067; B05C 5/002; B05C 5/02; B05D 7/02

(57) ABSTRACT

A method of producing a coated opaque article including a) applying from one or more inkjet heads a coating composition comprising at least 30 wt % of solvent to a surface of a transparent or opaque article to be coated; b) drying the coating composition for at least 30 seconds; and c) curing the coating composition to form a cured coating. The coating composition has a viscosity of from 5 to 50 cp at 25° C. and when the article to be coated is a transparent article, an opaque coating is applied to another surface of the article after step c), thereby rendering the coated article opaque.

### FIELD OF THE INVENTION

The present invention concerns methods of producing a coated opaque article with an even and high gloss surface finish.

### BACKGROUND OF THE INVENTION

For many applications, for example, for parts for motor vehicles or parts for electronic devices, it may be desirable to improve the surface characteristics of the article, for example to create an even and high gloss surface finish with anti-abrasion function, thereby improving both the visual appearance and the physical performance of the article. This can be achieved, for example, by applying a coating onto the surface of the article. The coating may provide a high gloss finish to the article as well as working as an anti-scratch, anti-abrasion or weather resistant protective layer for the article.

Various coating methods, for example dip coating, flow coating and spray coating, may be employed to apply a coating onto an article. However, a number of disadvantages are associated with the existing coating methods. In particular, the methods are capital intensive, requiring substantial facilities and services, as well as highly qualified technical support. Flow coating is often associated with waste of coating material and uneven coating thickness achieved across the article. Spray coating has the disadvantages of excessive waste, possible occurrence of an orange peel effect due to variable flow, uneven coating due to uneven drying and lateral application of the composition and inclusion of air bubbles due to high pressure used in the process. In addition to those disadvantages, the existing coating methods require masking of parts of the article if coating of only selected area is to be achieved, which makes the process more complex and labor-intensive.

The present invention. seeks to mitigate the above-mentioned problems. Alternatively or additionally, the present invention seeks to provide an improved method of producing a coated opaque article with an even and high gloss finish.

### SUMMARY OF THE INVENTION

According to a first aspect of the present invention, there is provided a method of producing a coated. opaque article. The method comprises a) applying from. one or more inkjet heads a coating composition comprising at least 30 wt % of solvent to a surface of a transparent or opaque article to be coated; b) drying the coating composition for at least 30 seconds; and c) curing the coating composition to form a cured coating. The coating composition has a viscosity of from 5 to 50 cp at 25° C. and when the article to be coated is a transparent article, an opaque coating is applied to another surface of the article after step c), thereby rendering the coated article opaque. Preferably, the article to be coated. is opaque. For example, the article to be coated may be formed from an opaque material or it may comprise a body of a transparent material having an opaque coating on at least one surface. The finished coated opaque article has a cured coating on an opaque, preferably black, region of the article. The cured. coating provides protection against abrasion and also gives a high gloss, attractive appearance.

It is found. that the present invention is capable of producing cured coatings which have consistent thickness, are less likely to have inclusions, have good resistance to abrasion and have a lower occurrence of “orange peel” effects.

Conventional inkjet printing requires near-instantaneous fixation of the ink once it is on the article in order to minimize flow of the ink to ensure precise registration or the printed image. The near-instantaneous fixation is in many cases achieved by having a curing station, for example a UV curing station, immediately downstream of the inkjet heads. The inks suitable for use in inkjet printing typically comprise at least 95% curable materials, sometimes 100% curable materials and have a viscosity of from 5 cp to 20 cp at 25° C. The ink is designed to be compatible with the instantaneous fixation and therefore the diluent in the ink composition is normally reactive, for example, reactive to UV radiation. Typically, inkjet inks comprise polymer material which may reduce the flow of the composition and/or low molecular weight curable diluents which may degrade anti-abrasion properties of the cured coating.

The method of the present invention comprises applying a coating composition comprising at least 30 wt % solvent via one or more inkjet heads. Inkjet heads having one or more nozzles are particularly suitable for the method of the present invention. Optionally, the one or more inkjet heads may be heated. Optionally, the coating composition comprises at least 40 wt %, for example 50 wt % solvent. Optionally, the coating composition comprises not more than 80 wt %, preferably not more than 70 wt %, for example, not more than 60 wt % solvent. The viscosity of the coating composition is from 5 to 50 cp, preferably from 5 to 20 cp, more preferably from 7 to 12 cp, at. 25° C. as measured on a Brookfield RVT Viscometer, Spindle No. RV2, 20 rpm. It is found that the coating composition of the present invention generally has excellent flowability which results in even and high gloss surface finish after curing. Optionally, the one or more inkjet heads will be positioned vertically above the article to be coated so that the direction of travel of the droplets of coating composition is vertically downwards, and the coated surface of the article will be generally horizontal. That arrangement may help to reduce any flow of the coating composition on the surface due to the effects of gravity. The vertical application of the coating composition may further enhance the surface property of the cured coating.

In the method of the present invention, step b) takes place prior to step c). Step b) of the present invention gives time to allow the coating composition to flow on the surface of the article to be coated, thereby achieving a smooth, high gloss surface. It also allows the solvent to evaporate before the coating composition is cured to prevent the solvent affecting the properties of the coating in the curing step. Optionally, step b) takes at least 40 seconds, for example at least 50 seconds. The present coating process therefore contrasts with known processes of inkjet printing of UV-curable inks, because in those known printing processes curing takes place almost instantaneously after the ink is applied to the substrates, with no intermediate drying step. Preferably, by the time step c) takes place, the coating composition comprises less than 5 wt %, preferably less than 3 wt %, more preferably less than 1 wt % solvent. For example, by the time step c) takes place, the coating composition comprises no measurable solvent. The drying step may involve simply passing the article through or along a path between the one or more inkjet heads and the curing station. Optionally, the article is heated during step b) by a heat source to facilitate the evaporation of the solvent. Suitable heat sources may include but are not limited to warm air or infrared radiation. Preferably, the heat source is arranged to enable the temperature of the coating composition to increase gradually. In that way, it is possible to avoid any sudden evaporation and/or boiling of the solvent which would mar the surface of cured coating.

Preferably, the coating composition is one which improves the abrasion resistance of the article (a hardcoat). For example, the coating composition. may be a hardcoat based on urethane, acrylic, epoxy, ester or scone compounds. Optionally, the hardcoat is based on either acrylates or siloxanes. Optionally, the hardcoat is silicone hardcoat. The cured coating provides not only an even and glossy finish to the surface of the article, but also a surface coating resistant to scratches and abrasion.

Preferably, the coating is an anti-abrasion coating. One method of testing abrasion resistance is to subject an article to a standard abrasion procedure and then measure the HAZE value of the abraded article. In the present invention, the HAZE value of the article to be coated after an abrasion procedure may be, for example, at least 30%. The abrasion procedure may be, for example, in accordance with ASTM D1044 in which a CS10F standard wheel having a 500 gram load is rotated 100 times on a sample. Preferably, the HAZE value of the abraded coated article is less than 10%, more preferably less than 8%, for example less than 7%. Preferably, the delta HAZE (the HAZE value of the abraded article to be coated. minus the HAZE value of the abraded coated article) is at least 20%, preferably at least 22%. The HAZE value may be a transmission HAZE value. Alternatively, the HAZE value may be a reflection HAZE value. Optionally, the HAZE value of an opaque article may be measured on a transparent test piece which is otherwise of the same material, has the same coating and has been subject to the same coating process as the opaque article to be tested.

The term “solvent” is used herein to indicate any non-curable solvent which is suitable for use in the coating composition. It is desirable that the surface energy of the coating composition is compatible with the surface of the article and that the viscosity of the coating composition is optimum for the intended application. The solvent is not curable when exposed to the conditions of the curing step c), such as UV radiation. Preferably, the solvent has a boiling point in the range of 80 to 150° C., preferably from 90 to 140° C. Suitable solvents include, but are not limited to, alcohols such as butyl-alcohol, ethers or ketones such as methyl isobutyl acetone, or a combination thereof. Preferably, the solvent is 1-methoxy-2-propanol. Preferably, the coating composition is non-toxic.

Optionally, the coating composition may comprise one or more additives. Possible additives may include but are not limited to weather resistance agents (for example UV absorbers), silica nanoparticles and/or the combination thereof. The coating composition is typically substantially transparent and colorless. Typically, the coating composition does not comprise a colorant. However, in some embodiments, the coating composition may also comprise a colorant, for example, a dye or a pigment, whilst still retaining its transparency. Optionally, the coating composition may further comprise oligomers, for example silicone-based oligomers or urethane acrylates.

Various curing methods may be used in the method according to the present invention. Suitable curing methods include but are not limited to electron beam, UV curing or thermal curing. Preferably, step b) comprises curing by UV. UV curing is rapid, flexible and easy to control. The strength of the UV light may be adjusted to take into account the effects of various additives, for example, UV absorbers, in the coating composition. The various additives in the coating composition may affect rate and/or extent of curing, which in turn may affect the abrasion resistance of the cured coating.

Optionally, the coating composition may comprise photo initiators, for example, in an amount of from 1 to 10 wt %, preferably from 1 to 5 wt %. Suitable photoinitiators are well known to the skilled person and includes benzophenones, thioxenthones, 2-amino alkyl phenones.

The thickness of the cured coating will depend on the intended application of the coated article and/or the nature of the coating. Optionally, the cured coating has a thickness of from 3 to 50 microns, preferably from 5 to 20 microns, more preferably from 7 to 12 microns. For example, for applications requiring weather resistance, the cured coating may have a thickness of 7 to 15 microns.

Preferably, the coated article has a cured coating exhibiting excellent consistency in thickness across the coated surface.

The transparent or opaque article to be coated may be made of any material compatible with the coating composition and the chosen curing method. Optionally, the article to be coated may be made of plastic such as a synthetic polymer material. For example, the article to be coated is made of acrylic, for example cast acrylic sheet, or polycarbonate. Preferably, the article to be coated is made of polycarbonate. Optionally, the article to be coated is injection moulded acrylic or polycarbonate or ABS. In one embodiment of the present invention, the article to be coated is a black moulded article made of ABS. Optionally, the article to be coated is cleaned prior to the coating process by a cleaning agent. The cleaning agent may be, for example, propanol or a water/propanol mixture. Preferably, the coated article used as an automotive component, such as a component in a car interior or exterior, for example a part of the dashboard or radio.

The coated opaque article produced by the method of the present invention may be of any color, for example, red, white or black. Preferably, the coated opaque article is black. The coated black article produced by the method of the present invention has a very desirable surface finish which is described in the art as a “piano black” finish.

Generally, the coated opaque article is opaque across its whole area. However, optionally, the coated opaque article further comprises a transparent area, for example, a transparent window. If present, any transparent area will preferably be less than 30%, preferably less than 10% of the total surface area of the coated article. The opaque area of the article will be coated according to the method of the present invention. If present, the transparent area may also be coated according to the method of the present invention. When the article to be coated is transparent, an opaque coating is applied to another surface of the article after step c), thereby rendering the article opaque. The opaque coating, for example a paint or an ink, may be applied by any suitable method such as screen printing, pad printing or painting. Optionally, the opaque coating is applied by means of inkjet printing.

Optionally, the article to be coated comprises a transparent body having an obverse surface and a reverse surface. The reverse surface comprises an opaque coating, and step a) of the method of the present invention involves applying the coating composition to the obverse surface of the article.

According to a second aspect of the present invention, there is provided an apparatus for producing a coated opaque article comprising a conveyor for supporting a transparent or opaque article to be coated; one or more inkjet heads containing a coating composition comprising at least 30 wt %; solvent and having a viscosity of from 5 to 50 cp at 25° C. and a curing station for curing the coating composition to form a cured coating. The one or more inkjet heads are arranged for applying the coating composition to a surface of the article to be coated. The inkjet heads and the curing station are arranged such that, in use, it takes at least 30 seconds for the article to travel from the one or more inkjet heads to the curing station.

The conveyor may be any device suitable for transporting the articles to be coated under the one or more inkjet heads and then to the curing station. For example, the conveyor may include a simple belt conveyor. Optionally, a plurality of articles to be coated are supported on a jig and the conveyor comprises an XY table, such that each of the articles on the jig can be positioned under the one or more inkjet heads for coating with the coating composition. The conveyors then conveys the jig and the articles to the curing station. Many suitable arrangements will be familiar to the skilled person.

Typically, the one or more inkjet heads comprises one or more nozzles. Optionally, the apparatus further comprises a control unit for controlling the one or more nozzles, thus enabling coating of selective areas of the article without masking.

Optionally, the apparatus of the present invention further comprises one or more heat sources between the one or more inkjet heads and the curing station.

According to a third aspect of the present invention, there is provided a coated opaque article produced by a method described herein.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows an article suitable for coating by the method of the invention;

FIG. 2 shows a flowchart according to an embodiment of the invention; and

FIG. 3 shows an apparatus according to an embodiment of the invention

### DETAILED DESCRIPTION

While the present invention has been described and illustrated with reference to particular embodiments, it will be appreciated by those of ordinary skill in the art that the invention. lends itself to many different variations not specifically illustrated herein. By way of example only, certain possible variations will now be described.

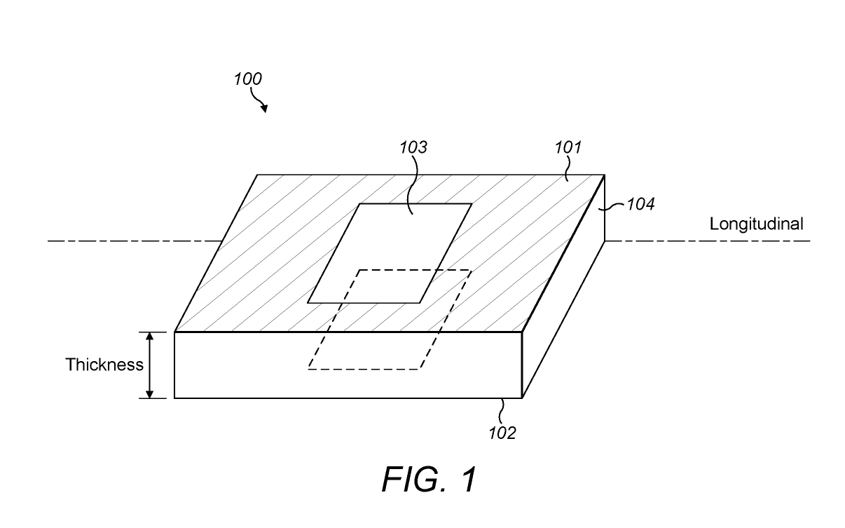

Referring now to FIG. 1, an article to be coated 100 has an obverse surface 101 and a reverse surface 102. The article 100 may be of any shape suitable for the intended application. Generally the article 100 may have a thickness of at least 500 microns, preferably at least 1 mm, more preferably at least 2 mm. Generally the thickness of the article will be at most 20 mm, preferably at most 15 mm, more preferably at most 12 mm and most preferably at most 10 mm. For example, the thickness of the article 100 may be in the range of 750 microns to 3 mm.

The size of the article 100 may be relatively small. For example, the article 100 may have a longitudinal dimension of up to 20 cm and a transverse dimension of up to 15 cm. The article 100 of the present invention may also be a larger article, for example an article suitable for use as a car window pillar.

The article 100 may be transparent or opaque. Optionally, the article 100 comprises a transparent body 104 and the reverse surface 102 of the article 100 comprises an opaque coating. Optionally, the article 100 may comprise a transparent area 103, for example, a display screen, which optionally is not coated with the coating composition.

Optionally, the obverse surface 101 of the article 100 is flat. Alternatively, the obverse surface 101 of the article is uneven such that it comprises one or more structures projecting from or recession into the obverse surface 101. Optionally, the distance between the highest point and the lowest point on the obverse surface 101 is from 0 to 20 mm.

In one embodiment of present invention, the coating composition is applied to the entire obverse surface 101 of the article 100. In another embodiment of the present invention, the coating composition is selectively applied to a portion of the obverse surface 101 of the article 100.

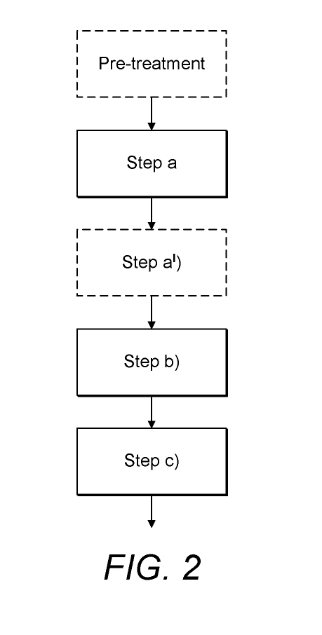

Now referring to FIG. 2, one embodiment of the present invention comprises step a) applying from one or more inkjet heads a coating composition to a surface 101 of the article 100; followed by step b) drying the coating composition for at least 30 seconds and followed by step c) curing the coating composition to form a cured coating. The coating composition comprises at least 30 wt % of solvent and has a viscosity of from 5 to 50 cp at 25° C. When the article to be coated is a transparent article, an opaque coating is applied to another surface of the article after step c), thereby rendering the coated article opaque.

Optionally, step b) further comprises heating the article with a heat source, for example by heated air. During step b), the temperature of the article may be increased from room temperature to about 50° C., optionally about 60° C., alternatively about 70° C.

Preferably, a pre-treatment is performed on the article to be coated prior to step a) of the present invention. The obverse surface 101 of the article 100 may, for example, be cleaned with a cleaning agent or a soft brush. The cleaning agent may be, for example, propanol or a water/propanol mixture.

Preferably the method of the present invention is performed in a clean environment substantially free from dust and other atmospheric contaminants which may detrimentally affect the coating process by causing defects in the coating or by affecting the bonding of the coating composition to the article and/or its subsequent curing. Preferably the method of the present invention is carried out in an environment separated from the ambient atmosphere. This may be achieved by operating the method of the present invention in a “clean room” or an “enclosure”, particularly a tent which has its own integral air/gas supply. In this way the tent atmosphere may be modified, e.g. to provide an inert atmosphere for the curing process and/or a positive tent pressure to exclude contaminants.

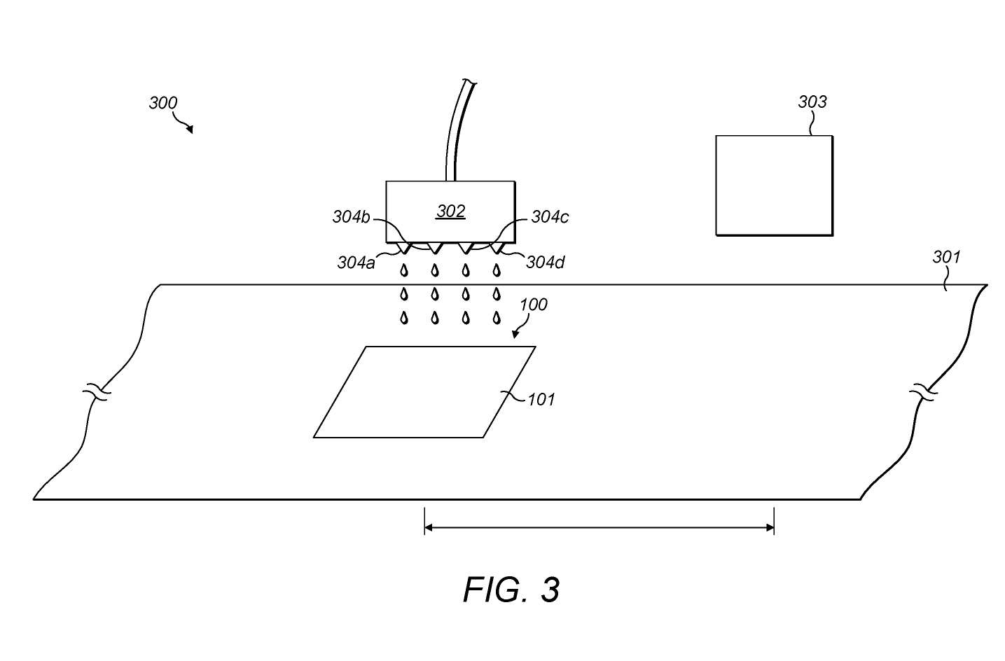

Now referring to FIG. 3, an apparatus 300 according to one embodiment of the present invention comprises a conveyor 301 for supporting an article to be coated 100, one inkjet head 302 and a curing station 303. The inkjet head 302 contains a coating composition (not shown) comprising at least 30 wt % solvent and. having a viscosity of from 5 to 50 cp at 25° C. The inkjet head 302 comprises one or more rows of inkjet nozzles (for clarity, only four rows of inkjet nozzles 304a to 304d are shown in the figure) for applying the coating composition to a surface 101 of the article 100. The distance between the inkjet head 302 and the curing station 303, and the speed of the conveyor are selected such that, in use, it takes at least 30 seconds for the article 100 to travel from the inkjet head 302 to the curing station.

The speed of the conveyer may be adjustable according to, for example, the required thickness of the cured coating and/or the required time for the article to travel through the drying zone. Optionally, the speed of the conveyer is from 1 m/min to 3 m/min, for example 2 m/min. The apparatus 300 may further comprise an air tunnel (not shown in FIG. 3) between the inkjet head 302 and the curing station 303, the air tunnel being arranged to heat the article 100 before it reaches the curing station 303.

The location and the height of the inkjet head 302 may also be adjustable according to, for example, the nature of the surface of the article to be coated. For example, if the surface is uneven, and has projecting or raised parts, the inkjet head can be arranged at a greater distance from the conveyor to allow the article to be coated to pass underneath. The inkjet head 302 may be connected to a control unit (not shown in FIG. 3). The thickness of the cured coating may be controlled by software and the thickness of the cured coating may be influenced by the choice of heads and the speed of the conveyer. The skilled person is familiar with inkjet heads suitable for inkjet printing which may be used in the present invention. The inkjet head may be, for example, a Konika Minolta® KM 1024MH head or a Konika Minolta® KM 1024LH head. The maximum coating width of the jet head may be from 50 to 100 mm, for example 75 mm. The size of the drops emitted from the jet head may be between 5 to 100 picolitres, optionally from 10 to 50 picolitres, for example 14 picolitres, alternatively 42 picolitres.

The distance between the obverse surface 101 of the article 100 and the jet head 302 may be from 1 mm to 20 mm, optionally from 1 mm to 5 mm, for example 2 mm. The small distance between the head and the surface to be coated reduces the risk of atmospheric disturbance and the vertical application of the coating composition reduces or eliminates the occurrence of “orange peel”.

The present invention is further described by way of Examples below.

### Example

### 1. Preparation of the Article to be Coated

The article to be coated was a plaque of opaque polycarbonate with a size of 70 mm×70 mm and a thickness of 3 mm. The article to be coated was pre-cleaned by wiping carefully with isopropanol using a lint free, soft cloth and allowed to dry. After the pre-cleaning, the article to be coated was placed on a conveyor in a position below the inkjet head.

### 2. Preparation of the Coating Composition

The coating composition was prepared by diluting a proprietary hardcoat formulation (purchased from Nano-X, Germany, reference number 3611, nominal solids: 50%) with 1-methoxy-2-propanol until the viscosity of the coating composition was approximately 9 cp as measured on a Brookfield RVT Viscometer, spindle No. RV2, 20 rpm at 25° C.

### 3. Setting Up of the Apparatus

The inkjet head used was a Konika Minolta® KM 1024LH, 42 picolitre ink jet head. The nozzle plate of the inkjet head is fixed at a height of 2 mm above the surface of the article to be coated. The coating resolution of the head across the plaque was 360 dpi and the resolution in the machine direction was set by the shaft encoder and the associated software. The curing station was a UV unit (Fusion 300) based on a medium pressure mercury vapour lamp with reflector and air cooling. The energy rating of the UV unit was 300 watts per inch and was set up around 100 mm above the conveyor. A drying tunnel was arranged between the inkjet heads and the curing station. The length of the drying tunnel was 2 meters. A temperature gradient was established along the drying tunnel by using three individually controlled heating units to ensure a gradient along the zone from 25° C. at the coating station to approximately 70° C. just before the UV unit to control rate of evaporation.

### 4. Coating of the Article

The linear speed of the conveyor was set at 2 m/min, so that each plaque took 60 seconds to travel through the drying tunnel. During the drying step, all the solvent was removed from the coating composition prior to reaching the UV curing unit. The coated plaque was then passed under the UV unit while travelling at the same general process speed of 2 m/min.

Whilst the present invention has been described and illustrated with reference to particular embodiments, it will be appreciated by those of ordinary skill in the art that the invention lends itself to many different variations not specifically illustrated herein.

1-13. (canceled)

14. A method of producing a coated opaque article, the method comprising:
a) applying from one or more inkjet heads a coating composition comprising at least 30 wt % of solvent to a surface of a transparent or opaque article to be coated; b) drying the coating composition for at least 30 seconds; and c) curing the coating composition to form a cured coating; wherein:
the coating composition has a viscosity of from 5 to 50 cp at 25° C., and wherein:
when the article to be coated is a transparent article, an opaque coating is applied to another surface of the article after step c).

15. The method according to claim 14, wherein the cured coating has a thickness in the range of from 3 to 50 microns.

16. The method according to claim 14, wherein the coating composition has a viscosity in the range of from 7 to 12 cp at 25° C.

17. The method according to claim 14, wherein the distance between the one or more inkjet heads and the surface of the article to be coated is in the range of from 2 to 20 mm.

18. The method according to claim 14, wherein the solvent is 1-methoxy-2-propanol.

19. The method according to claim 14, wherein the coating composition is a transparent, colorless, hardcoat composition.

20. The method according to claim 14, wherein step c) comprises curing the coating composition by UV.

21. The method according to claim 14, wherein the article to be coated is formed from injection moulded acrylic or polycarbonate.

22. The method according to claim 14, wherein the article to be coated comprises a transparent body having an obverse surface and a reverse surface, and the reverse surface comprises an opaque coating, and step a) further comprises applying the coating composition to the obverse surface of the article.

23. An apparatus for producing a coated opaque article, comprising:
a conveyor for supporting a transparent or opaque article to be coated;
one or more inkjet heads containing a coating composition comprising at least 30 wt % solvent and having a viscosity of from 5 to 50 cp at 25° C.; and
a curing station for curing the coating composition to form a cured coating; wherein:
the one or more inkjet heads and the curing station are arranged such that, in use, it takes at least 30 seconds for the article to travel from the one or more inkjet heads to the curing station.

24. An apparatus according to claim 23, wherein the apparatus further comprises a heat source between the one or more inkjet heads and the curing station.

25. An apparatus according to claim 23, wherein the coating composition is a transparent, colorless, hardcoat composition.
